(19) United States
(12) Patent Application Publication
(10) Pub. No.: US 2015/0099063 A1
(43) Pub. Date: Apr. 9, 2015

(54) METHOD OF PRODUCING LAYERS FOR SOLID OXIDE FUEL CELLS

(71) Applicant: PHILLIPS 66 COMPANY, Houston, TX (US)

(72) Inventors: Ying Liu, Bartlesville, OK (US); Timothy L. Sirmon, Collinsville, OK (US); Ralph Melton, Bartlesville, OK (US); Ting He, Bartlesville, OK (US)

(73) Assignee: PHILLIPS 66 COMPANY, Houston, TX (US)

(21) Appl. No.: 14/507,122

(22) Filed: Oct. 6, 2014

Related U.S. Application Data
(60) Provisional application No. 61/888,204, filed on Oct. 8, 2013.

(51) Int. Cl. H01M 8/12

(52) U.S. Cl. CPC H01M 8/1246; H01M 8/1253; H01M 8/126; H01M 2300/0074; H01M 2300/0077; H01M 2008/1293
USPC 427/115

(57) ABSTRACT

A method of forming layers of a solid oxide fuel cell. The method begins by pumping a volume of a slip form a slip reservoir to a separator reservoir. A separator and a blade are provided upon a carrier to form the separator reservoir with a gap formed between the blade and the carrier. The carrier is operated so that the carrier is transported from the separator to the blade. A layer of slip is then deposited from the separator reservoir onto the carrier. The layer of slip is then dried on the carrier.

### CROSS-REFERENCE TO RELATED APPLICATIONS

This application is a non-provisional application which claims the benefit of and priority to U.S. Provisional Application Ser. No. 61/888,204 filed Oct. 8, 2013, entitled “Method of Producing Layers for Solid Oxide Fuel Cells,” which is hereby incorporated by reference in its entirety.

### STATEMENT REGARDING FEDERALLY SPONSORED RESEARCH OR DEVELOPMENT

None.

### FIELD OF THE INVENTION

A method of producing layer for solid oxide fuel cells.

### BACKGROUND OF THE INVENTION

The world relies heavily on energy produced from fossil fuels, but as a non-renewable energy source (at least in our lifetimes), fossil fuels have serious limitations. The ever-increasing demand and dwindling supply of fossil fuels will inevitably cause significant problems in the future. In remote areas of developing countries, transmission and distribution of fossil fuel-generated energy can be difficult and expensive. Additionally, the burning of fossil fuels results in the formation of smog and global warming, and further contributes to our environmental problems. Thus, developing a clean alternative energy industry is key to improving the quality of life for individuals and communities, and to ameliorate global warming and other environmental problems.

The critical technical barrier to the widespread application of various alternative energy technologies is performance limitations of the key materials. For example, in solar-fuel production, the efficiency is relatively low since the current photocathode materials show sluggish H₂ evolution reaction kinetics and the photoanode materials have insufficient light absorption and carrier collection capabilities. In wind power, the lifetime of turbine blades currently made of polymer-matrix composite materials reinforced with fiberglass or graphite fibers can be further enhanced when a new material with adequate stiffness to prevent failure as well as sufficient long term fatigue in harsh conditions is developed. Therefore, materials science and technology plays a pivotal role in building the world's energy future, from fundamental discovery science, to improving energy production processes. The discovery and optimization of new materials could effectively advance solutions to our energy challenges.

The demand for clean, secure, and renewable energy has stimulated great interest in fuel cells. Fuel cells are one distinct category of devices that are capable of converting chemical energy into electrical energy. Among the fuel cells that are currently under active development, alkaline, polymeric-electrolyte-membrane and phosphoric-acid fuel cells all require essentially pure hydrogen as the fuel to be fed to the anode.

Solid Oxide Fuel Cells (“SOFCs”), on the other hand, are a type of fuel cells that use a solid oxide or ceramic as the electrolyte of a cell. The basic solid oxide fuel cell is generally made up of three layers. A single cell consisting of these three layers stacked together is typically only a few millimeters thick. Hundreds of these cells are then connected in series to form what most people refer to as an “SOFC stack”. The ceramics used in SOFCs do not become electrically and ionically active until they reach very high temperature and as a consequence the stacks have to run at temperatures ranging from 500 to 1,000° C. Reduction of oxygen into oxygen ions occurs at the cathode. These ions can then diffuse through the solid oxide electrolyte to the anode where they can electrochemically oxidize the fuel. In this reaction, a water byproduct is given off as well as two electrons. These electrons then flow through an external circuit where they can do work. The cycle then repeats as those electrons enter the cathode material again.

SOFCs offer great promise for the most efficient and cost-effective utilization of a wide variety of fuels such as hydrocarbons, coal gas and gasified biomass. Because of the relatively high operating temperature (500-1000° C.), the fuel processing reaction can be carried out within the cell stacks without additional fuel processors. Another advantage of SOFCs is the fuel flexibility. A wide variety of practical hydrocarbons such as methane, propane, gasoline, diesel and kerosene can be directly utilized as the fuels in SOFCs. The direct utilization of hydrocarbon fuels will increase the operating efficiency and reduce system costs, which will accelerate substantially the use of SOFCs in transportation, residential and distributed-power application. Among the hydrocarbon fuels, natural gas such as methane is regarded as relatively cheap and popularly available fuel with plenty of deposits. Additionally, SOFCs that can directly run on natural gas would highly reduce the operating cost and accelerate the commercialization of SOFC system.

The basic chemical reactions at the anode side of an SOFC is the oxidation of fuels, such as hydrogen gas and/or carbon monoxide, to generate electrons:

Anode: H₂+O²⁻→H₂O+2e⁻

and/or

CO+O²⁻→CO₂+2e⁻

The reaction at the cathode side is the reduction of oxygen to oxygen ions:

Cathode: O₂+4e⁻2O²⁻

Therefore, the overall reaction of an SOFC becomes:

Overall: H₂+½O₂→H₂O

Or

H₂+CO+O₂→H₂O+CO₂

Therefore, SOFCs typically run on pure hydrogen or mixture of hydrogen and carbon monoxide by internally or externally reforming a hydrocarbon fuel, while air serves as the oxidant. As shown above, if pure hydrogen is used, then the product is pure water, whereas carbon dioxide is produced if carbon monoxide is also used.

In an effort to reduce fuel electrode manufacturing costs, sintering processes have been attempted, such as those described in U.S. Pat. Nos. 4,971,830, 5,035,962, 5,908,713 and 6,248,468. However, fuel electrodes applied by a sintering process are relatively time consuming in that it still requires at least two processing steps, an initial application followed by high temperature sintering. Moreover, sintered fuel electrodes may experience marginal physical stability over time.

Other attempts to reduce fuel electrode fabrication costs include plasma spraying (e.g. atmospheric plasma spraying “APS”, vacuum plasma spraying “VPS”, plasma arc spraying, flame spraying) which generally involves spraying a molten powdered metal or metal oxide onto an underlying substrate surface using a plasma thermal spray gun to form a deposited layer having a microstructure generally characterized by accumulated molten particle splats. Plasma spraying techniques are described in U.S. Pat. Nos. 3,220,068, 3,839,618, 4,049,841, and U.S. Pat. Nos. 3,823,302 and 4,609,562 generally teach plasma spray guns and use thereof, each of which are herein incorporated by reference in their entirety. Although plasma spraying has been used for fabrication of certain fuel cell layers, such as those described in U.S. Pat. Nos. 5,085,742, 5,085,742, 5,234,722 5,527,633 (plasma sprayed electrolyte) U.S. Pat. No. 5,426,003 (plasma sprayed interconnect), U.S. Pat. No. 5,516,597 (plasma sprayed interlayer) and U.S. Pat. No. 5,716,422 (plasma sprayed air electrode), use of such plasma spraying techniques have been of limited value when used to apply a fuel electrode onto an electrolyte because they tend to result in a fuel electrode that poorly adheres to the electrolyte and exhibits poor thermal cyclability due to the mismatch of thermal coefficients of expansion between the metal portion of the fuel electrode and the ceramic electrolyte. Moreover, these conventional plasma spraying techniques tends to result in a fuel electrode that has a low porosity after continued use, thereby causing voltage loss when current flows as a result of polarization due to a low rate of diffusion of fuel gases into and reaction product out from the interface between the fuel electrode and electrolyte.

There is thus a need for a method for making the SOFC that can generally achieve above-described favorable technical properties and can be manufactured at a low cost.

### BRIEF SUMMARY OF THE DISCLOSURE

A method of forming layers of a solid oxide fuel cell. The method begins by pumping a volume of a slip form a slip reservoir to a separator reservoir. A separator and a blade are provided upon a carrier to form the separator reservoir with a gap formed between the blade and the carrier. The carrier is operated so that the carrier is transported from the separator to the blade. A layer of slip is then deposited from the separator reservoir onto the carrier. The layer of slip is then dried on the carrier.

A method of forming layers of a solid oxide fuel cell. The method begins by consistently pumping a volume of a slip from a slip reservoir to a separator reservoir. A separator and a blade are provided upon a carrier to form the separator reservoir with a gap between the blade and the carrier between 50 nm to about 1 μm. The carrier is operated so that a roll of carrier material is continuously transported from the separator to the blade. A layer of slip is deposited from the separator reservoir onto the carrier the thickness of the gap, wherein the volume of slip from the slip reservoir to the separator reservoir is greater than the volume of slip deposited onto the carrier. The overflow of the slip in the separator reservoir flows into the slip reservoir. Thee layer of slip is then dried on the carrier to produce a dried solid oxide fuel cell layer on top of the carrier.

### BRIEF DESCRIPTION OF THE DRAWINGS

A more complete understanding of the present invention and benefits thereof may be acquired by referring to the follow description taken in conjunction with the accompanying drawings in which:

FIG. 1 depicts a traditional method of applying a layer for a solid oxide fuel cell.

FIG. 2 depicts the traditional thickness of a layer of a solid oxide fuel cell from the beginning to the end.

FIG. 3 depicts the traditional thickness of a layer of a solid oxide fuel cell from the edges of the tape.

FIG. 4 depicts the present methods of applying a layer for a solid oxide fuel cell.

FIG. 5 depicts the present method's thickness of a layer of a solid oxide fuel cell from the beginning to the end.

FIG. 6 depicts the present method's thickness of a layer of a solid oxide fuel cell from the edges of the tape.

### DETAILED DESCRIPTION

Turning now to the detailed description of the preferred arrangement or arrangements of the present invention, it should be understood that the inventive features and concepts may be manifested in other arrangements and that the scope of the invention is not limited to the embodiments described or illustrated. The scope of the invention is intended only to be limited by the scope of the claims that follow.

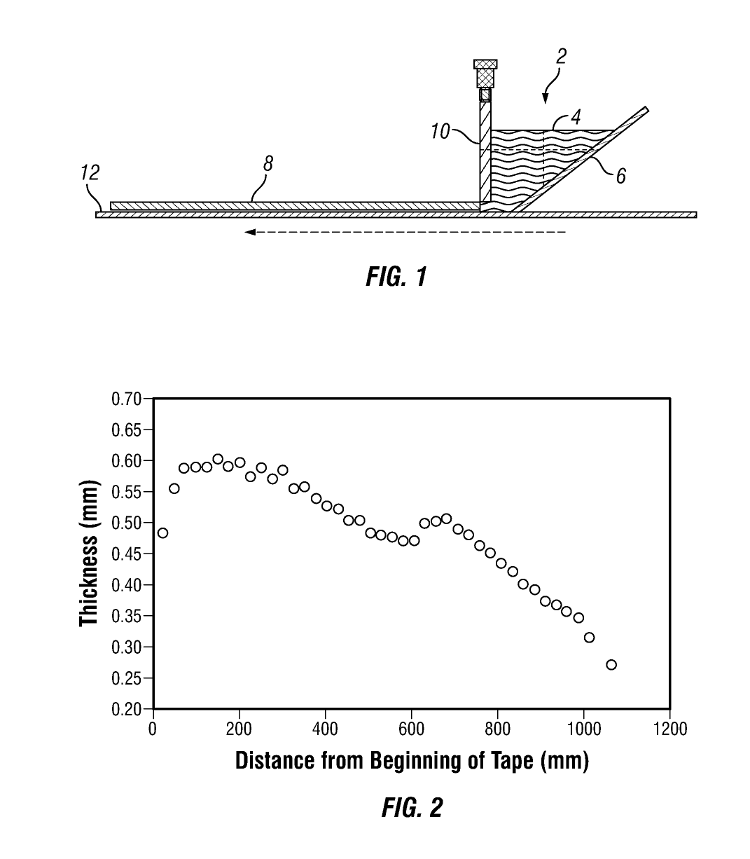

Traditionally, the method of applying a layer onto a carrier for solid oxide fuel cells involved a reservoir 2 which housed a slip 4 between a plate 6; plastic film carrier 12 and a blade 10 (see FIG. 1). In this traditional method the carrier 12 would be moved from the right to the left.

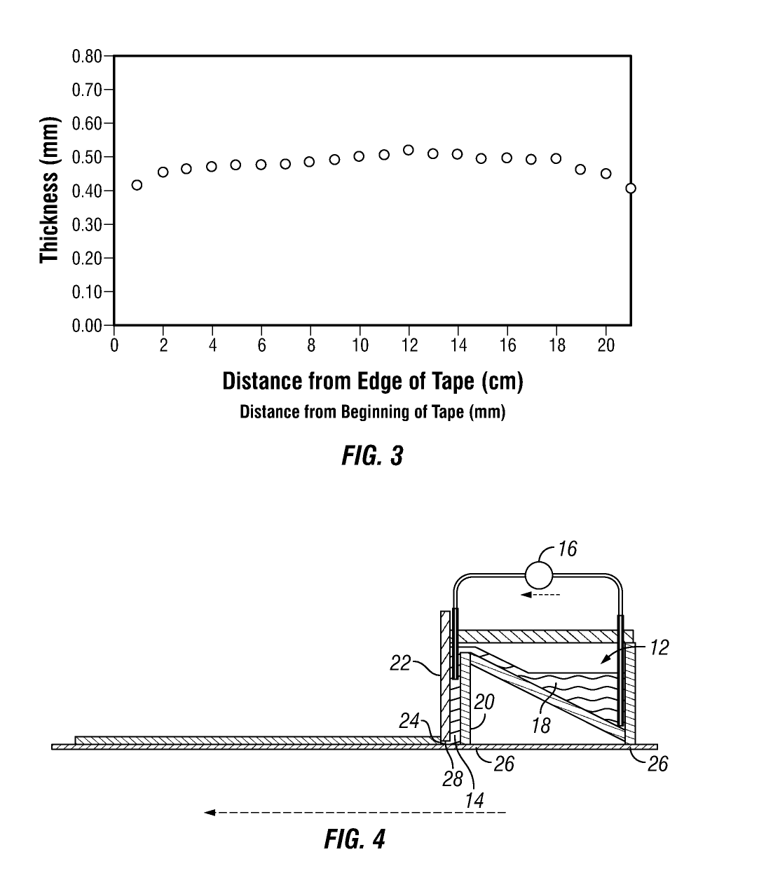

However, such a method resulted in uneven thickness from the beginning of the tape to the end (FIG. 2) and from the edges of the tape (FIG. 3).

The present embodiment describes a method of forming layers of a solid oxide fuel cell. The method begins by pumping a volume of a slip form a slip reservoir to a separator reservoir. A separator and a blade are provided upon a carrier to form the separator reservoir with a gap formed between the blade and the carrier. The carrier is transported from the separator to the blade. A layer of slip is then deposited from the separator reservoir onto the carrier. The layer of slip is then dried on the carrier.

FIG. 4 depicts an embodiment of the method. In this method a volume of slip 18 is pumped from the slip reservoir 12 to the separator reservoir 14. In one embodiment the volume of the slip 18 is continuously pumped from the slip reservoir 12 to the separator reservoir 14. Any type of pump 16 commonly known to one skilled in the art can be used to flow the slip 18 from one reservoir to the other. Some different kinds of pumps that can be used include a progressive cavity pump, rotary lobe pump, rotary gear pump, piston pump, diaphragm pump, screw pump, gear pump, hydraulic pump, vane pump, regenerative pump, peristaltic pump, or a rope pump.

The separator reservoir 14 is formed by the combination of a separator 20 and a blade 22, located upon a carrier 24. The separator 20 is used to separate the slip reservoir 12 from the separator reservoir 14 and in one embodiment is in contact with the carrier 24. As shown in the figure the blade 22 and the carrier 24 form a gap 28. The size of the gap can be anywhere from about 50 nm to about 1 μm or even 3 mm to about 5 μm.

The carrier 24 is transported from the separator 20 to the blade 22. In one embodiment a roll of carrier material is continually transported from the separator 20 to the blade 22. A layer of slip 18 is then deposited from the separator reservoir 14 onto the carrier 24. In one embodiment the layer of slip 18 deposited upon the carrier 24 is the thickness of the gap 28.

In yet another embodiment the volume of slip 18 from the slip reservoir 12 to the separator reservoir 14 is greater than the volume of slip 18 deposited onto the carrier 24, which results in constant head pressure during the deposition of the slip onto the carrier. In yet another embodiment the overflow of the slip 18 in the separator reservoir 14 is flowed into the slip reservoir 12.

In one embodiment the slip forms an anode in the solid oxide fuel cell. The anode is typically porous to allow the fuel to flow towards the electrolyte. Anodes are typically chosen for their (1) high electrical conductivity; (2) a thermal expansion that matches those of the adjoining components; (3) the capacity of avoiding coke deposition; (4) fine particle size; (5) chemical compatibility with another cell components (electrolyte and interconnector) under a reducing atmosphere at the operating temperature; (6) large triple phase boundary; (7) high electrochemical or catalytic activity for the oxidation of the selected fuel gas; (8) high porosity (20-40%) adequate for the fuel supply and the reaction product removal; and (9) good electronic and ionic conductive phases. In the current SOFC any known anode can be utilized. Types of anodes that can be used include Ni/YSZ, Cu/Ni, and perovskite structures with a general formula of ABO₃. In the perovskite structure the A cations can be group 2, 3, or 10 elements or more specifically cations such as, La, Sr, Ca or Pb. Also in the perovskite structure the B cations can be group 4, 6, 8, 9, or 10 elements or more specifically cations such as Ti, Cr, Ni, Fe, Co or Zr. Other materials that the anode could be include nickel oxide, nickel, yittria stabilized zirconia, scandia stabilized zirconia, gadolinium doped ceria, samarium doped ceria, doped barium zirconate cerate, or combinations thereof.

In yet another embodiment, the anode can be pre-reduced at a temperature from about 400° C. to about 800° C. in a reducing atmosphere containing 1-100% hydrogen or other reducing gas atmospheres.

In one embodiment the slip forms a cathode in the solid oxide fuel cell. The cathode is typically porous to allow the oxygen reduction to occur. Any cathode material known to those skilled in the art can be used. One example of cathode materials that are typically used includes perovskite-type oxides with a general formula of ABO₃. In this embodiment, the A cations can be lower valance cations such as La, Sr, Ca or Pb. The B cations can be metals such as Ti, Cr, Ni, Fe, Co or Zr. Examples of these perovskite-type oxides include LaMnO₃. In one differing embodiment the perovskite can be doped with a group 2 element such as Sr²⁺ or Ca²⁺. In another embodiment, cathodes such as Pr_{0.5}Sr_{0.5}FeO₃; Sr_{0.9}Ce_{0.1}Fe_{0.8}Ni_{0.2}O₃; Sr_{0.8}Ce_{0.1}Fe_{0.7}Co_{0.3}O₃; LaNi_{0.6}Fe_{0.4}O₃; Pr_{0.8}Sr_{0.2}Co_{0.2}Fe_{0.8}O₃; Pr_{0.7}Sr_{0.3}Co_{0.2}Mn_{0.8}O₃; Pr_{0.8}Sr_{0.2}FeO₃; Pr_{0.6}Sr_{0.4}Co_{0.8}Fe_{0.2}O₃; Pr_{0.4}Sr_{0.6}Co_{0.8}Fe_{0.2}O₃; Pr_{0.7}Sr_{0.3}Co_{0.9}Cu_{0.1}O₃; Ba_{0.5}Sr_{0.5}Co_{0.8}Fe_{0.2}O₃; Sm_{0.5}Sr_{0.5}CoO₃; or LaNi_{0.6}Fe_{0.4}O₃ can be utilized. Other materials that the cathode could be include lanthanum strontium iron cobalt oxide, doped ceria, strontium samarium cobalt oxide, lanthanum strontium iron oxide, lanthanum strontium cobalt oxide, barium strontium cobalt iron oxide, or combinations thereof.

In one embodiment the slip forms an electrolyte in the solid oxide fuel cell. The electrolyte used in the solid oxide fuel cell is responsible for conducting ions between the electrodes, for the separation of the reacting gases, for the internal electronic conduction blocking, and for forcing the electrons to flow through the external circuit. Some of the typical characteristics that electrolytes typically invoke include (1) an oxide-ion conductivity greater than 10⁻² S.cm⁻¹ at the operating temperature; (2) negligible electronic conduction, which means an electronic transport number close to zero; (3) high density to promote gas impermeability; (4) thermodynamic stability over a wide range of temperature and oxygen partial pressure; (5) thermal expansion compatible with that of the electrodes and other cell materials from ambient temperature to cell operating temperature; (6) suitable mechanical properties, with fracture resistance greater than 400 MPa at room temperature; (7) negligible chemical interaction with electrode materials under operation and fabrication conditions to avoid formation of blocking interface phases; (8) ability to be elaborated as thin layers (less than 30 μm); and (9) low cost of starting materials and fabrication.

In the current solid oxide fuel cell the electrolyte can be any electrolyte known to those skilled in the art. In one embodiment the electrolyte is a dense stabilize zirconia or a doped ceria. In one embodiment the electrolyte comprises a porous BZCYYb as the backbone and carbonate as the secondary phase within the pores of.

The weight ratio of BZCYYb in the composite electrolyte may vary, as long as the composite electrolyte can reach higher conductivity as well as current density as compared to non-composite electrolyte. In one embodiment, the weight ratio of BZCYYb in the composite electrolyte ranges from 9:1 to 1:1, but more preferably ranges from 50-90% or 70-80%. In another embodiment, the weight ratio of BZCYYb is about 75%.

The weight percentage of carbonate in the composite electrolyte also may vary, as long as the composite electrolyte can maintain physical integrity during operation. In one embodiment, the weight percentage of carbonate in the composite electrolyte ranges from 10 to 50 wt %. In another embodiment, the weight percentage of carbonate in the composite electrolyte ranges from 20 to 30 wt %, in yet another embodiment, the carbonate is about 25%.

In one example of preparing BZCYYb lithium-potassium carbonate is typically made first. Stoichiometrical amount of Li₂CO₃ and K₂CO₃ were mixed in the weight proportion of 45.8:52.5 and milled in a vibratory mill for 1 hour. The mixture was then heated to 600° C. for 2 hours. The heated mixture was then quenched in air to the room temperature and ground. The resulting lithium-potassium carbonate was used later in the preparation of composite electrolyte with BZCYYb.

In one embodiment the BZCYYb powder was prepared by solid-state reaction, but other methods could also be used. Stoichiometric amounts of high-purity barium carbonate, zirconium oxide, cerium oxide, ytterbium oxide and yttrium oxide powders (all from Sigma-Aldrich® Chemicals) were mixed by ball milling in ethanol (or other easily evaporated solvent) for 24 h, followed by drying at 80° C. for overnight and calcinations at 1100° C. in air for 10 h. The calcinated powder was ball milled again, followed by another calcination at 1100° C. in air for 10 h to produce single phase BZCYYb.

The resulted BZCYYb powder and the carbonate obtained above were mixed at weight ratio of 75:25 and thoroughly ground again for one hour. The mixture was then heated to 680° C. for 60 minutes until only the carbonate melted and wet the BZCYYb grain boundaries in the mixture. Next, it was quenched (i.e. fast cooling) in air to room temperature. The quenched mixture was ground again to get the composite electrolyte powder.

In another example an alternate way of preparing BZCYYb powder can be described. In this embodiment stoichiometric amounts of high-purity barium carbonate, zirconium oxide, cerium oxide, ytterbium oxide, and yttrium oxide powders (all from Sigma-Aldrich® Chemicals) were mixed by ball milling in ethanol for 48 h, followed by drying in an oven and calcination at 1100° C. in air for 10 h. The calcined powder was ball milled again, followed by another calcination at 1100° C. in air for 10 h.

The CeO₂ and ZrO₂ powders with different particle sizes were used to optimize the fabrication procedures. To prepare electrolyte samples for the conductivity measurement, we pressed the calcined powders isostatically into a disk at 274.6 MPa. The green disks had a diameter of 10 mm, with a typical thickness of 1 mm. The disks were then sintered at 1500° C. for 5 h in air (relative density>96%).

In some embodiments a Sc-doped BZCY powder can be prepared. In one example of this embodiment BZCY—Sc with a nominal composition of BaCe_{0.7}Zr_{0.1}Y_{0.1}Sc_{0.1}O_{3-δ}(BZCY—Sc) was synthesized by a conventional solid state reaction (SSR) method. Stoichiometric amount of high-purity barium carbonate, zirconium oxide, cerium oxide, yttrium oxide and scandium oxide powders (BaCO₃:ZrO2:CeO₂:Y₂O₃:Sc₂O₃=167.33:12.32:120.48:22.58:13.79, all from Sigma-Aldrich® Chemicals) were mixed by ball milling in ethanol for 24 hours, followed by drying at 80° C. for overnight and calcinations at 1100° C. in air for 10 hours. The calcined powder was ball milled again, followed by another calcination at 1100° C. in air for 10 hours to produce single phase BZCY—Sc.

In the present method, the calcining step can be carried out at preferably higher than 1000° C. in air for 10 hours. However, the temperature and the length of calcination can vary, depending on different factors to be considered, such as the particle size chosen. The particle size of the zirconium oxide powder is preferably between 50 nm and 200 nm, and more preferably between 50 nm and 100 nm. The particle size of the cerium oxide powder is preferably between 50 nm and 500 nm, and more preferably between 50 nm and 200 nm.

The materials used for the separator and the blade can be any material that are unreactive with the slip. In one embodiment the carrier material is plastic.

It would be possible in the present embodiment to only deposit the anode or only the cathode or only the electrolyte layer of the solid oxide fuel cell. In alternate embodiments it would be possible to continuously form a solid oxide fuel cell by having continuous system wherein a dried solid oxide fuel cell anode layer followed by a dried solid oxide fuel cell electrolyte layer on top of the dried solid oxide fuel cell anode layer and then a dried solid oxide fuel cell cathode layer on top of the dried solid oxide fuel cell electrolyte layer is formed without removing the solid oxide fuel cell from the carrier.

Each slip layer formed by the present method can be identical to the one before it or different. In one embodiment each layer formed by this method is repeated at least two times. In another embodiment each layer formed by this method is repeated at least three times. In one embodiment, the forming of the layers is repeated till the cumulative thickness of the slip is at least 1 μm. In another embodiment the thickness of the deposited layers has a variance of less than one sigma.

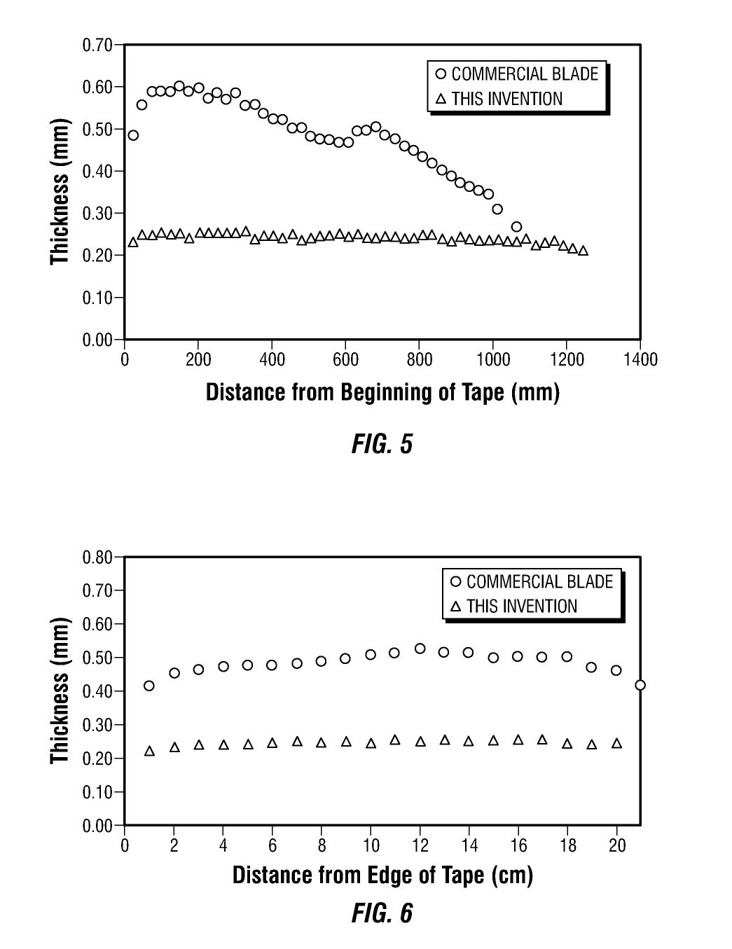

As shown in FIG. 5 and in FIG. 6 the present method allows for even thickness from the beginning of the tape to the end (FIG. 5) and from the edges of the tape (FIG. 6).

In closing, it should be noted that the discussion of any reference is not an admission that it is prior art to the present invention, especially any reference that may have a publication date after the priority date of this application. At the same time, each and every claim below is hereby incorporated into this detailed description or specification as an additional embodiment of the present invention.

Although the systems and processes described herein have been described in detail, it should be understood that various changes, substitutions, and alterations can be made without departing from the spirit and scope of the invention as defined by the following claims. Those skilled in the art may be able to study the preferred embodiments and identify other ways to practice the invention that are not exactly as described herein. It is the intent of the inventors that variations and equivalents of the invention are within the scope of the claims while the description, abstract and drawings are not to be used to limit the scope of the invention. The invention is specifically intended to be as broad as the claims below and their equivalents.

1. A method of forming layers of a solid oxide fuel cell comprising:
pumping a volume of a slip from a slip reservoir to a separator reservoir;
providing a separator and a blade upon a carrier to form the separator reservoir;
forming a gap between the blade and the carrier;
operating the carrier so that the carrier is transported from the separator to the blade;
depositing a layer of slip from the separator reservoir onto the carrier; and
drying the layer of slip on the carrier.

2. The method of claim 1, wherein the volume of the slip is continuously pumped from the slip reservoir to the separator reservoir.

3. The method of claim 1, wherein the gap formed between the blade and the carrier is between 50 nm to about 1 μm.

4. The method of claim 1, wherein the separator is in contact with the carrier.

5. The method of claim 1, wherein the carrier is operated so that a roll of carrier material is continuously transported form the separator to the blade.

6. The method of claim 1, wherein the layer of slip deposited onto the carrier is the thickness of the gap.

7. The method of claim 1, wherein the volume of slip from the slip reservoir to the separator reservoir is greater than the volume of slip deposited onto the carrier.

8. The method of claim 7, wherein the overflow of the slip in the separator reservoir is flowed into the slip reservoir.

9. The method of claim 1, wherein the slip forms an anode in the solid oxide fuel cell.

10. The method of claim 1, wherein the slip forms a cathode in the solid oxide fuel cell.

11. The method of claim 1, wherein the slip forms an electrolyte in the solid oxide fuel cell.

12. A method of forming layers of a solid oxide fuel cell comprising:
consistently pumping a volume of a slip from a slip reservoir to a separator reservoir;
providing a separator and a blade upon a carrier to form the separator reservoir;
forming a gap between the blade and the carrier between 50 nm to about 1 μm;
operating the carrier so that a roll of carrier material is continuously transported from the separator to the blade;
depositing a layer of slip from the separator reservoir onto the carrier the thickness of the gap, wherein the volume of slip from the slip reservoir to the separator reservoir is greater than the volume of slip deposited onto the carrier;
flowing the overflow of the slip in the separator reservoir into the slip reservoir; and
drying the layer of slip on the carrier to produce a dried solid oxide fuel cell layer on top of the carrier.

13. The method of claim 12, wherein an anode layer of the solid oxide fuel cell is selected from a mixture comprising an electronic conductor and an ionic conductor.

14. The method of claim 13, wherein the electronic conductor is selected from the group consisting of: NiO, CO-oxide, CuO or combinations thereof.

15. The method of claim 13, wherein the ionic conductor is selected from the group consisting of: yittria stabilized zirconia, scandia stabilized zirconia, gadolinium doped ceria, samarium doped ceria, doped barium zirconate cerate or combinations thereof.

16. The method of claim 12, wherein a cathode layer of the solid oxide fuel cell is selected from a mixture comprising an electronic conductor and an ionic conductor.

17. The method of claim 16, wherein the electronic conductor is selected from the group comprising: lanthanum strontium iron cobalt oxide, strontium samarium cobalt oxide, lanthanum strontium iron oxide, lanthanum strontium cobalt oxide, baraium strontium cobalt iron oxide or combinations thereof.

18. The method of claim 16, wherein the ionic conductor is selected from the group comprising: doped ceria, stabilized zirconia and combinations thereof.

19. The method of claim 12, wherein an electrolyte layer of the solid oxide fuel cell is a dense stabilized zirconia.

20. The method of claim 12, wherein an electrolyte layer of the solid oxide fuel cell is a doped ceria.

21. The method of claim 12, wherein an electrolyte layer of the solid oxide fuel cell is a porous BZCYYb electrolyte.

22. The method of claim 12, wherein an electrolyte layer of the solid oxide fuel cell is a Sc doped BZCY.

23. The method of claim 12, wherein only an anode layer of the solid oxide fuel cell is formed.

24. The method of claim 12, wherein only a cathode layer of the solid oxide fuel cell is formed.

25. The method of claim 12, wherein only an electrolyte layer of the solid oxide fuel cell is formed.

26. The method of claim 12, wherein another slip is deposited onto the dried solid oxide fuel cell layer using the same method.

27. The method of claim 12, the solid oxide fuel cell is continuously formed by forming a dried solid oxide fuel cell anode layer followed by a dried solid oxide fuel cell electrolyte layer on top of the dried solid oxide fuel cell anode layer and then a dried solid oxide fuel cell cathode layer on top of the dried solid oxide fuel cell electrolyte layer without removing the solid oxide fuel cell from the carrier.

28. The method of claim 12, wherein the slip forms an anode in the solid oxide fuel cell.

29. The method of claim 12, wherein the slip forms a cathode in the solid oxide fuel cell.

30. The method of claim 12, wherein the slip forms an electrolyte in the solid oxide fuel cell.
